(19) United States
(12) Patent Application Publication
(10) Pub. No.: US 2006/0151274 A1
(43) Pub. Date: Jul. 13, 2006

(54) Lock-up clutch device

(75) Inventors: Yoshio Kinoshita, Shizuoka (JP); Shiro Takeuchi, Shizuoka (JP); Tatsuro Miyoshi, Shizuoka (JP); Shigeki Umezawa, Shizuoka (JP); Shun Kitahara, Shizuoka (JP); Tamotsu Fujii, Shizuoka (JP); Hiroyuki Kinpara, Shizuoka (JP); Kenji Maruo, Shizuoka (JP); Tomoyuki Miyazaki, Shizuoka (JP); Xiaoming Gu, Shizuoka (JP); Fumimasa Muramatsu, Shizuoka (JP); Shigeharu Nishimura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: NSK-WARNER KABUSHIKI KAISHA

(21) Appl. No.: 11/293,090

(22) Filed: Dec. 5, 2005

(30) Foreign Application Priority Data
Dec. 3, 2004 (JP) P. 2004 - 351075

(51) Int. Cl. F16H 45/02

(52) U.S. Cl. 192/3.28; 192/113.36

(57) ABSTRACT

In a torque converter equipped with a lock-up clutch device, a friction member is put on either one of a front cover and a lock-up piston which are to be brought into contact. On the front cover, coupling members are welded for coupling with an engine. Owing to welding distortion, convex portions are generated on a friction face. Thus, when the friction member is put on either side of the front cover and clutch piston, if relative rotation slippage occurs therebetween, a positive pressure and a negative pressure are produced in front of and behind each convex portion, which leads to the stick/slip. This invention gives grooves 71 each exceeding the range of a welding portion 61 of the coupling member 6 which are formed on the friction face of the friction member 7, which realizes balancing in a change in pressure.

The present application claims foreign priority under 35 USC 119 based on Japanese Patent Application No. 2004-351075, filed on Dec. 3, 2004, the contents of which is incorporated herein by reference in its entirety, and concurrently with the filing of this U.S. patent application.

### BACKGROUND OF THE INVENTION

This invention relates to a lock-up clutch device for use in the torque converter of an automatic transmission, which can prevent shudder due to stick/slip.

FIG. 1 is a sectional view of the basic structure of a torque converter equipped with a lock-up clutch device. A torque converter 10 includes a pump 2, a turbine 3 and a stator 4. An outer shell 22 of the pump 2 is coupled with a front cover 21 which is driven by an engine. Reference-numeral 23 denotes a blade and reference numeral 24 denotes an inner core.

Further, referring to FIG. 1, reference numeral 32 denotes an outer shell of a turbine 3; 33 a blade; 34 an inner core; 4 a stator, 51 a lock-up clutch piston; 52 a damper; 53 a spring; and 35 a turbine hub. The outer shell 32 is coupled with the turbine hub 35 and damper 52 by a rivet 54. Reference numeral 7 is a friction member which may be put on either side of the front cover 21 and piston 51. Line X-X denotes the center line of the entire torque converter.

The operation of the torque converter, which is a well known technique, will not be explained here. The problem of torque converter equipped with the lock-up clutch device is that the clutch piston serves as a vibrator and the damper and others serve as an elastic body so that in start of clutch engagement or start of release thereof, the front cover and clutch piston repeat relative stick and slip therebetween through the friction member according to its characteristic, thereby generating possible shudder due to stick/slip.

The friction member includes fiber and resin diluted in a solvent. And when the solvent is volatized after molding, internal resin moves together with solvent near the surface of the friction member. As a result, a resin layer with high density is formed near the surface of the friction member, thereby giving the high static friction coefficient. Namely, when a slip rotary speed is low, the friction coefficient increases. This generates the shudder due to the stick/slip in the start of engagement of the clutch-up or release thereof. In order to obviate such an inconvenience, traditionally, the surface of a required portion of the friction member is cut by a predetermined quantity so that the portion of the resin with a low density appears on the surface. This portion, which gives a low static friction coefficient, is first brought into contact with a complementary member. Next, the remaining portion not cut is brought into contact with the complementary member. Thus, occurrence of the shudder due to the stick/slip can be prevented.

Patent Reference: JP-A-5-99297

As seen from FIG. 1 and FIG. 2 when seen from direction D in FIG. 1, the front cover 21 of the torque converter 10 used in the automatic transmission is coupled with a plurality of nuts or bolts (generally referred to as bosses 6) by welding for the purpose of coupling with the engine. In FIG. 2, shaded portions 61 denote welding regions. It is needless to say that the inner surface of the front cover 21 is sufficiently finely finished. However, since the bosses 6 are welded, the distortion of the welding portions inevitably reaches the inner surface of the front cover 21. Thus, when the friction member is put on the front cover 21, convex portions appear on the friction face of the friction member. When the friction member is put on the side of the clutch piston 51, the concave portions appear on the friction face of the side of the front cover onto which the friction member on the clutch piston 51 side is pressed. In any case, when the friction member and the complementary member relatively pass in contact at the internal convex portions in the areas of the front cover 21 where the bosses 6 are welded, a positive pressure and a negative pressure are generated in front of and behind each the convex portions. This is equivalent to that the pressure pressing the clutch piston 51 onto the front cover 21 instantaneously varies, and hence that the friction coefficient changes. Thus, as described in connection with the prior art, the change in the pressure, which leads to the shudder due to stick/slip, must be avoided.

In order to solve the above problem, this invention provides a lock-up clutch device in which each of oil reservoirs is formed to exceed a welding range of a coupling member on the surface of a friction member put on the connecting portion of the lock-up clutch device.

In accordance with this invention, a change in oil pressure. i.e. occurrence in the positive pressure and the negative pressure, which is attributable to the convex portions due to welding deformation generated by welding the bosses on the front cover of the torque converter for coupling with the engine, can be alleviated by forming the oil reservoirs each exceeding the welding range on the friction face of the friction member. Thus, occurrence in the shudder due to slip/stick can be prevented.

### BRIEF DESCRIPTION OF THE DRAWINGS

FIG. 1 is a sectional view of the basic structure of a torque converter provided with a lock-up clutch device.

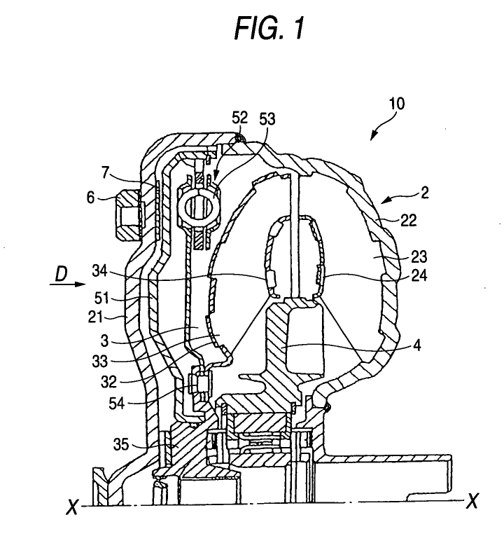

FIG. 2 is an end face view when viewed from direction D in FIG. 1.

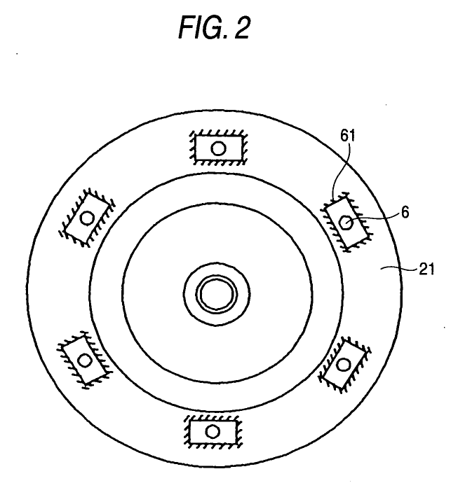

FIG. 3 is a front view showing the first embodiment of this invention.

FIG. 4 is a front view showing the second embodiment of this invention.

FIG. 5 is a front view showing the third embodiment of this invention.

FIG. 6 is a front view showing the fourth embodiment of this invention.

FIG. 7 is a front view showing the fifth embodiment of this invention.

FIG. 8 is a front view showing the sixth embodiment of this invention.

FIG. 9 is a front view showing the seventh embodiment of this invention.

FIG. 10 is a front view showing the eighth embodiment of this invention.

FIG. 11 is a front view showing the ninth embodiment of this invention.

FIG. 12 is a front view showing the tenth embodiment of this invention.

### DETAILED DESCRIPTION OF THE PREFERRED EMBODIMENTS

Each of the oil reservoirs according to this invention may be an arc-shaped groove with both ends closed, or a group of small depressions with any shape such as a circle, ellipse or polygon. When the lock-up clutch piston is brought into contact with the front cover, initially, it is brought into contact on the outer periphery of the friction member, so that the arc-shaped groove is preferably formed on the outer peripheral side with respect to the center of the friction member.

Incidentally, if like the prior art, the surface of the friction member is cut by a predetermined quantity and further this invention is carried out, the effect of preventing the shudder can be further enhanced.

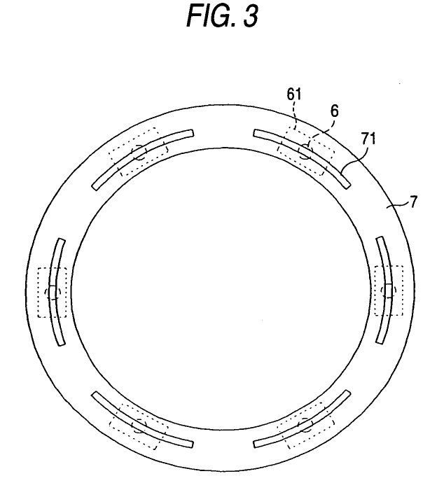

FIG. 3 is a front view showing the first embodiment of this invention. In this embodiment, each of oil reservoirs is formed as a groove 71 with both closed ends in an arc-shape having a length exceeding a welding range of a coupling member 6 on the friction face of a friction member 7.

As described above, the friction member 7 may be put on either side of the clutch piston 51 and the front cover 21. Where a friction member 7 is put on the front cover 21, the convex portion due to the distortion of the welding portion 61 appears on the friction face of the friction member 7. However, since the groove 71 has a length exceeding the welding range, the positive pressure and negative pressure generated in front and behind the convex portion in press-contact with the surface of the piston can be balanced with each other.

Where the friction member 7 is put on the piston 51, the grooves 71 sequentially pass the convex portions on the front cover 21 appearing on the friction face with the clutch piston 51. Therefore, the positive pressure and negative pressure generated when the grooves pass the convex portions can be likewise balanced by the grooves 71.

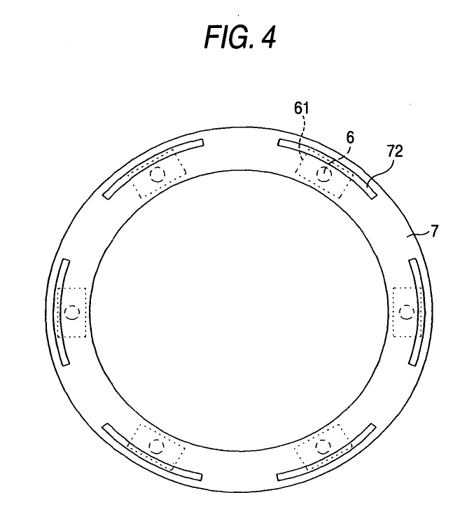

FIG. 4 is a front view showing a second embodiment of this invention. In this embodiment, the arc-shaped grooves 72 are formed on the outer peripheral side with respect to the center of the friction face. When the lock-up clutch is tightened, the central area of the clutch piston 51 warps toward the front cover 21 by oil pressure. Correspondingly, the front cover 21 and the piston 51 are aslant arranged so that they are not in parallel and near on the outer peripheral side of the friction face. Thus, they are bought in contact initially from outer peripheral side. For this reason, it is efficient to provide the oil reservoirs 71 on the outer peripheral side.

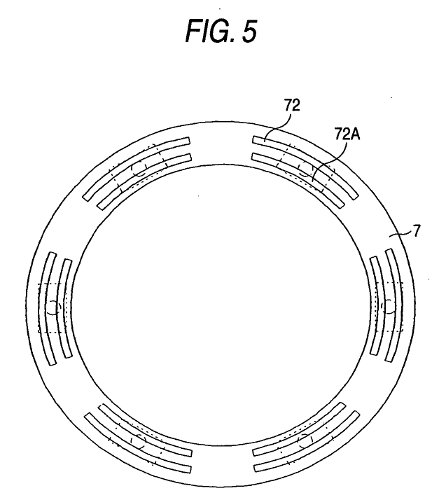

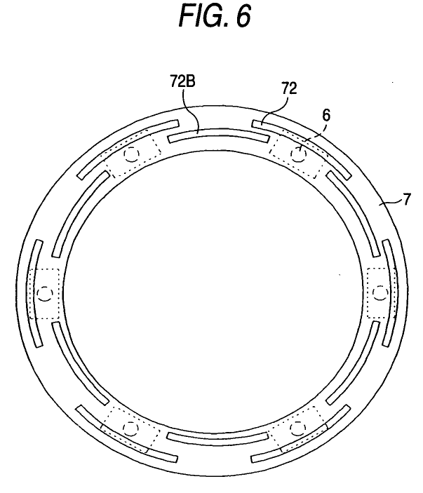

FIG. 5 is a front view showing the third embodiment of this invention. In this embodiment, in addition to the grooves 72 on the outer peripheral side of the friction member 7, grooves 72A are formed on the inner peripheral side thereof. FIG. 6 is a front view showing the fourth embodiment. In this embodiment, in addition to the grooves 72 on the outer peripheral side, each of grooves 72B is formed between the adjacent coupling members 6.

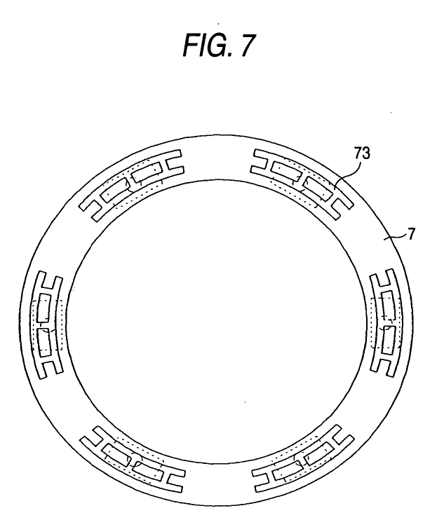

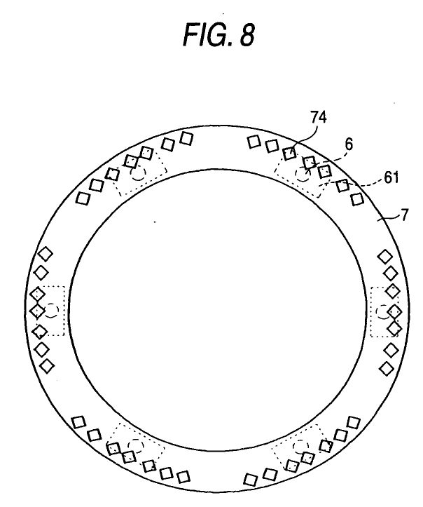

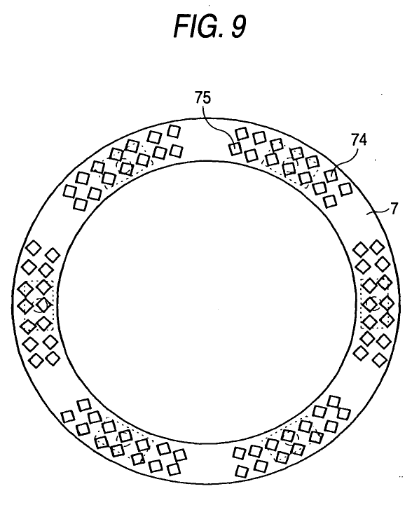

FIG. 7 is a front view showing the fifth embodiment of this invention. In this embodiment, grooves 73 each having a ladder-like shape including a plurality of grooves coupled with one another. FIG. 8 is a front view showing the sixth embodiment of this invention. In this embodiment, oil reservoirs 74 each including a group of a tiny depressions are formed. FIG. 9 is a front view showing the seventh embodiment. In this embodiment, in addition to the oil reservoirs 74 on the outer peripheral side, oil reservoirs 75 are formed also on the inner peripheral side. In FIGS. 8 and 9, although the depressions are illustrated as squares, they may be formed in any shape such as a circle, ellipse, lozenge and polygon.

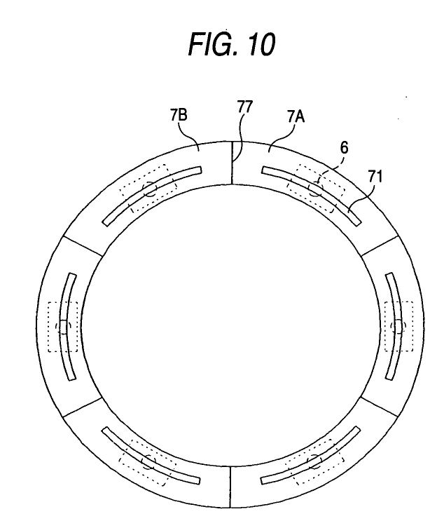

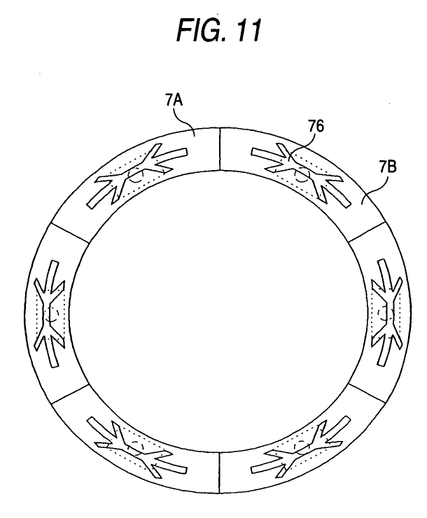

FIG. 10 is a view showing the eighth embodiment. In this embodiment, the friction member 7 is circumferentially divided into segments 7A, 7B, . . . whose number is equal to that of the coupling members 6. FIG. 11 is a front view showing the ninth embodiment. In this embodiment also, the friction member 7 is divided in the same manner as FIG. 10. However, it should be noted that in FIG. 10, the grooves 71 each is formed in the same arc-shape as in FIG. 3, whereas in FIG. 11, grooves 76 each is formed in the arc-shape with circumferentially angled branches. In FIGS. 10 and 11, reference numeral 77 denotes a joint in the friction member 7.

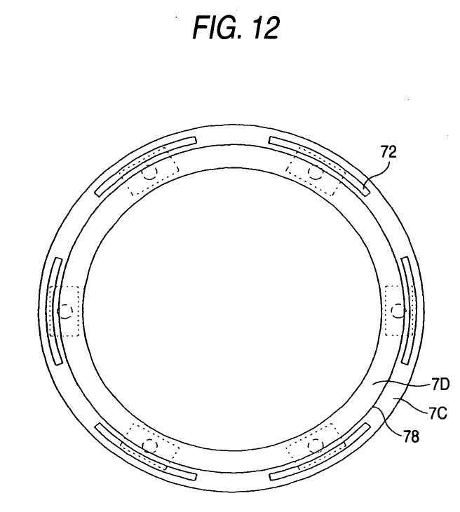

FIG. 12 is a front view showing the tenth embodiment. In this embodiment, the friction member 7 is radially divided into an outer peripheral zone 7C and inner peripheral zone 7D. In the outer peripheral zone 7C, grooves 72 on the outer peripheral side as shown in FIG. 4 are formed.

In the lock-up clutch device of the torque converter, if the surface condition of the friction member and the shape of a surface complementary to the friction member are bad, pressure of an oil film at a contact face varies so that self-induced vibration called shudder due to stick/slip occurs. This invention can prevent occurrence of such shudder, thereby improving driving stability and riding comfort.

What is claimed is:

1. A lock-up clutch device for use in a torque converter,
the lock-up clutch device comprising:
a connecting portion,
coupling members for coupling with an engine attached to the outer end face of the front cover of the torque converter, and
oil reservoirs each exceeding a welding range which is formed on a friction face of a friction member put on the connecting portion of the lock-up clutch device.

2. The lock-up clutch device according to claim 1, wherein
each the oil reservoirs is an arc-shaped groove with both closed ends.

3. The lock-up clutch device according to claim 1, wherein
each the oil reservoirs is formed on the outer peripheral side with respect to a center of the friction face of the friction member.

4. The lock-up clutch device according to claim 1, wherein
each the oil reservoirs is a groove with circumferentially angled branches.

5. The lock-up clutch device according to claim 1, wherein
each the oil reservoirs includes a plurality of connected grooves each with both closed ends.

6. The lock-up clutch device according to claim 1, wherein
each the oil reservoirs includes a group of tiny depressions each with any optional shape.

7. The lock-up clutch device according to claim 1, wherein
the friction member is circumferentially divided into a plurality of segments whose number is equal to that of the coupling members.

8. The lock-up clutch device according to claim 1, wherein
the friction member is radially divided into an inner peripheral zone and an outer peripheral zone.

9. The lock-up clutch device according to claim 2, wherein
each the oil reservoirs is formed on the outer peripheral side with respect to a center of the friction face of the friction member.

10. The lock-up clutch device according to claim 2, wherein
each the oil reservoirs is a groove with circumferentially angled branches.
